(19) United States
(12) Patent Application Publication
(10) Pub. No.: US 2022/0298305 A1
(43) Pub. Date: Sep. 22, 2022

(54) Thermally Conductive Non-Oil Bleed Liquid Thermal Interface Materials

(71) Applicant: SanDisk Technologies LLC, Addison, TX (US)

(72) Inventors: Vigneshwarram KUMARESAN, Penang (MY); Mutharasu DEVARAJAN, Penang (MY)

(21) Appl. No.: 17/204,552

(22) Filed: Mar. 17, 2021

(51) Int. Cl. C08G 77/08; G11B 33/14; C08K 3/38; C08K 3/22; C08L 83/04

(52) U.S. Cl. CPC C08G 77/08; G11B 33/1413; C08K 3/38; C08K 3/22; C08L 83/04; C08K 2003/385; C08K 2003/2227; C08G 77/12

(57) ABSTRACT

A liquid thermal interface material (LTIM) utilized in electronic devices includes a first part and a second part, where the first and second parts of the LTIM are individually synthesized. The first part and the second part are mixed together, dispensed into an electronic device, and the LTIM is at least partially cured. The first part comprises a dimethylpolysiloxane comprising resin, an oxide filler, a nitride filler, a catalyst comprising platinum, and a cyclohexanol comprising inhibitor. The second part comprises a polydimethylsiloxane comprising chain extender, a polymethylhydrosiloxane comprising crosslinker, a methylpolysiloxane comprising adhesive agent, the oxide filler, and the nitride filler. The cured LTIM has a thermal conductivity between about 4.5 W/mK to about 5.5 W/mK and a density less than about 2 g/cc. The cured LTIM does not bleed oil, thereby preventing contamination and damage of the electronic device.

### BACKGROUND

Embodiments of the present disclosure generally relate to a liquid thermal interface material for use in electronic devices, such as data storage devices.

Liquid thermal interface materials (LTIMs) are widely used to dissipate heat generated by electronic components, such as processing units, controllers, and memory devices, within electronic devices, for example storage devices, such as solid state drives (SSDs) and hard disk drives (HDDs). LTIMs play a role in the thermal management of such electronic devices by providing a low thermal impedance path between the components that generate heat and a heat sink and/or an enclosure. While the LTIMs currently being utilized have high thermal conductivity and good heat dissipation performance, the LTIMs often cause oil bleeding to occur on the exterior of the electronic devices. Oil bleeding from the LTIMs can cause contamination, cosmetic damage, and reduce the adhesion strengths used in the assembly and packaging of such devices.

Therefore, there is a need in the art for a non-oil bleeding liquid thermal interface material having a high thermal conductivity.

### SUMMARY

The present disclosure generally relates to a liquid thermal interface material (LTIM) utilized in electronic devices. The LTIM comprises a first part and a second part, where the first and second parts are individually synthesized. The first part and the second part are mixed together, dispensed into an electronic device, and the LTIM is at least partially cured. The first part comprises a dimethylpolysiloxane comprising resin, an oxide filler, a nitride filler, a catalyst comprising platinum, and a cyclohexanol comprising inhibitor. The second part comprises a polydimethylsiloxane comprising chain extender, a polymethylhydrosiloxane comprising crosslinker, a methylpolysiloxane comprising adhesive agent, the oxide filler, and the nitride filler. The cured LTIM has a thermal conductivity between about 4.5 W/mK to about 5.5 W/mK and a density less than about 2 g/cc. The cured LTIM does not bleed oil, thereby preventing contamination and damage of the electronic device.

In one embodiment, a LTIM comprises an at least partially cured resin composition, wherein, prior to at least partially curing, the resin composition comprises a first part and a second part. The first part comprises a resin comprising polysiloxane in an amount of about 1 wt% to about 12 wt% of the first part, an oxide filler in an amount of about 50 wt% to about 70 wt% of the first part, a nitride filler in an amount of about 20 wt% to about 40 wt% of the first part, a catalyst in an amount of about 0.001 wt% to about 0.05 wt% of the first part; and an inhibitor in an amount of about 0.003 wt% to about 0.05 wt% of the first part. The second part comprises a chain extender comprising methylsiloxane in an amount of about 0.1 wt% to about 2 wt% of the second part, a crosslinker in an amount of about 0.01 wt% to about 0.5 wt% of the second part, an adhesive agent in an amount of about 1 wt% to about 12 wt% of the second part, the oxide filler in an amount of about 50 wt% to about 70 wt% of the second part, and the nitride filler in an amount of about 15 wt% to about 40 wt% of the second part.

In another embodiment, a storage device comprises an at least partially cured liquid thermal interface material (LTIM), wherein, prior to at least partially curing, the LTIM comprises a first part and a second part. The first part comprises a resin comprising dimethylpolysiloxane, an aluminum oxide filler, a boron nitride filler, a catalyst comprising platinum, and an inhibitor comprising cyclohexanol. The second part comprises a chain extender comprising polydimethylsiloxane, a crosslinker comprising polymethylhydrosiloxane, an adhesive agent comprising methylpolysiloxane, the aluminum oxide filler, and the boron nitride filler. The LTIM has a thermal conductivity between about 4.5 W/mK to about 5.5 W/mK, a density less than about 2 g/cc, and a dielectric constant at 1 MHz between about 4.8 and about 5.5.

In yet another embodiment, an electronic device comprises an at least partially cured liquid thermal interface material (LTIM), wherein, prior to at least partially curing, the LTIM comprises a first part and a second part. The first part comprises a resin comprising polysiloxane in an amount of about 1 wt% to about 12 wt% of the first part, an aluminum oxide filler in an amount of about 50 wt% to about 70 wt% of the first part, and a boron nitride filler in an amount of about 20 wt% to about 40 wt% of the first part. The second part comprises a chain extender comprising methylsiloxane in an amount of about 0.1 wt% to about 2 wt% of the second part, the aluminum oxide filler in an amount of about 50 wt% to about 70 wt% of the second part, and the boron nitride filler in an amount of about 15 wt% to about 40 wt% of the second part. The LTIM has a thermal conductivity between about 4.5 W/mK to about 5.5 W/mK and a density less than about 2 g/cc.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a storage device may function as the storage device for a host device, according to one embodiment.

FIG. 2 is a perspective underside schematic of a storage device, according to another embodiment.

FIG. 3 illustrates a method of forming a LTIM utilized within an electronic device such as the storage device of FIGS. 1 and 2, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a liquid thermal interface material (LTIM) utilized in electronic devices. Although the embodiments shown and discussed below make particular reference to storage devices, it is to be understood that the invention may be used with other electronic devices, and may be applicable to other industries, such as automotive electronics, telecommunications etc. The LTIM comprises a first part and a second part, where the first and second parts are individually synthesized. The first part and the second part are mixed together, dispensed into an electronic device, and the LTIM is at least partially cured. The first part comprises a dimethylpolysiloxane comprising resin, an oxide filler, a nitride filler, a catalyst comprising platinum, and a cyclohexanol comprising inhibitor. The second part comprises a polydimethylsiloxane comprising chain extender, a polymethyl-hydrosiloxane comprising crosslinker, a methylpolysiloxane comprising adhesive agent, the oxide filler, and the nitride filler. The cured LTIM has a thermal conductivity between about 4.5 W/mK to about 5.5 W/mK and a density less than about 2 g/cc. The cured LTIM does not bleed oil, thereby preventing contamination and damage of the electronic device.

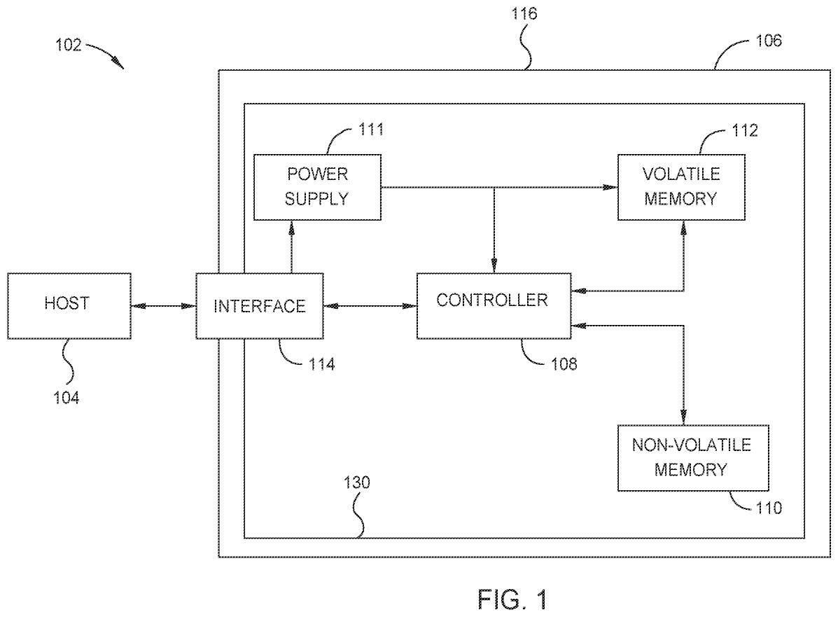

FIG. 1 is a conceptual and schematic block diagram illustrating a storage system 102 in which storage device 106 may function as a storage device for host device 104, in accordance with one or more techniques of this disclosure. For instance, host device 104 may utilize non-volatile memory devices included in storage device 106 to store and retrieve data. In some examples, storage system 102 may include a plurality of storage devices, such as storage device 106, which may operate as a storage array. For instance, storage system 102 may include a plurality of storages devices 106 configured as a redundant array of inexpensive/independent disks (RAID) that collectively function as a mass storage device for host device 104.

Storage system 102 includes host device 104 which may store and/or retrieve data to and/or from one or more storage devices, such as storage device 106. As illustrated in FIG. 1, host device 104 may communicate with storage device 106 via interface 114. Host device 104 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

As illustrated in FIG. 1, storage device 106 is disposed within a housing or an enclosure 116 and includes controller 108, non-volatile memory 110 (NVM 110), power supply 111, volatile memory 112, and interface 114. In some examples, storage device 106 may include additional components not shown in FIG. 1 for sake of clarity. For example, storage device 106 may include a printed board (PB) to which components of storage device 106 are mechanically attached and which includes electrically conductive traces that electrically interconnect components of storage device 106, or the like. In some examples, the physical dimensions and connector configurations of storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, storage device 106 may be directly coupled (e.g., directly soldered) to a motherboard of host device 104.

Storage device 106 includes interface 114 for interfacing with host device 104. Interface 114 may include one or both of a data bus for exchanging data with host device 104 and a control bus for exchanging commands with host device 104. Interface 114 may operate in accordance with any suitable protocol. For example, interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non- volatile memory express (NVMe), or the like. The electrical connection of interface 114 (e.g., the data bus, the control bus, or both) is electrically connected to controller 108, providing electrical connection between host device 104 and controller 108, allowing data to be exchanged between host device 104 and controller 108. In some examples, the electrical connection of interface 114 may also permit storage device 106 to receive power from host device 104. For example, as illustrated in FIG. 1, power supply 111 may receive power from host device 104 via interface 114.

Storage device 106 includes NVM 110, which may include a plurality of memory devices. NVM 110 may be configured to store and/or retrieve data. For instance, a memory device of NVM 110 may receive data and a message from controller 108 that instructs the memory device to store the data. Similarly, the memory device of NVM 110 may receive a message from controller 108 that instructs the memory device to retrieve data. In some examples, each of the memory devices may be referred to as a die. In some examples, a single physical chip may include a plurality of dies (i.e., a plurality of memory devices). In some examples, each memory devices may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory device of NVM 110 may include any type of non-volatile memory devices, such as flash memory devices, phase- change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

Flash memory devices may include NAND or NOR based flash memory devices, and may store data based on a charge contained in a floating gate of a transistor for each flash memory cell. In NAND flash memory devices, the flash memory device may be divided into a plurality of blocks which may divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines.

The controller 108 may write data to and read data from NAND flash memory devices at the page level and erase data from NAND flash memory devices at the block level. The controller 108 may manage one or more operations of storage device 106. For instance, controller 108 may manage the reading of data from and/or the writing of data to non-volatile memory 110. The controller 108 may be configured to receive workloads of data from the host device 104 via the interface 114. The controller may further be configured to perform a diagnosis of the data storage device 106, and may be configured to recalibrate one or more parameters of the storage device 106.

Storage device 106 includes power supply 111, which may provide power to one or more components of storage device 106. When operating in a standard mode, power supply 111 may provide power to the one or more components using power provided by an external device, such as host device 104. For instance, power supply 111 may provide power to the one or more components using power received from host device 104 via interface 114. In some examples, power supply 111 may include one or more power storage components configured to provide power to the one or more components when operating in a shutdown mode, such as where power ceases to be received from the external device. In this way, power supply 111 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area / volume) of the one or more power storage components. In other words, as the amount of power stored by the one or more power storage components increases, the cost, and/or the size of the one or more power storage components also increases.

Storage device 106 also includes volatile memory 112, which may be used by controller 108 to store information. In some examples, controller 108 may use volatile memory 112 as a cache. For instance, controller 108 may store cached information in volatile memory 112 until cached information is written to non-volatile memory 110. As illustrated in FIG. 1, volatile memory 112 may consume power received from power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like)).

The storage device 106 further comprises a liquid thermal interface material (LTIM) 130 disposed within the interior of the device 106 around one or more components known to produce heat when being used, such as the controller 108 and the NVM 110. The LTIM 130 may be disposed between the heat generating component and a heat sink (not shown) and/or a substrate (not shown) within the interior of the storage device 106. While the LTIM 130 is schematically shown as a generic layer surrounding the components of the storage device 106, the LTIM 130 may be disposed one or more components, or disposed around each individual component of the device 106. As discussed further below, the LTIM 130 is a highly cross-linked non-oil bleed two-part silicone material that can be used as a thermal gap filler within storage devices 106.

The LTIM 130 conducts heat away from the heat producing components during device operation, and thermally isolates the heat producing components of the storage device 106. For example, heat generated by the controller 108 and/or the NVM 110 can be efficiently removed from the interior of the enclosure 116 of the device 106, allowing the storage device 106 to remain at a consistent, operating-safe temperature during usage. The LTIM 130 further prevents oil from the LTIM 130 from bleeding onto the exterior of the enclosure 116.

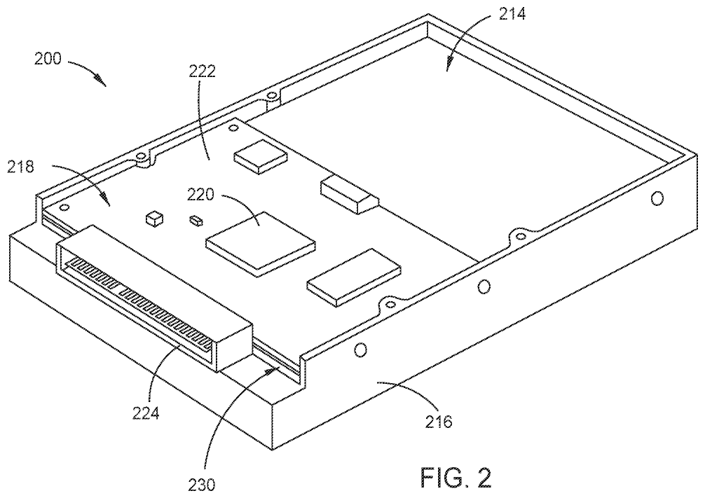

FIG. 2 is a perspective underside schematic of a storage device 200, according to another embodiment. The storage device 200 may be the storage device 106 of FIG. 1. A housing or enclosure 216 encloses various aspects of the storage device 200, such as, in the case of a hard disk drive, one or more magnetic recording discs connected to a spindle motor, a preamplifier/driver circuit, transducer heads, a voice coil motor, etc. For reference, the enclosure 216 and those aspects enclosed therein are sometimes referred to as a head- disc assembly (HDA) 214. Alternatively, the housing or enclosure 216 may enclose other storage devices 200 such as solid state drives. The discussion below will be with regards to a hard disk drive, but it is to be understood that the explanation is applicable to solid state drives as well.

A printed circuit board assembly (PCBA) 218 is secured to the HDA 214 and incorporates various electronic modules 220 of the device 200 used to control the HDA 214, such as a programmable controller, an interface circuit, a buffer, read and write channels, servo circuit, etc. The electronic modules are affixed to a rigid, printed circuit board (PCB) 222. Various circuits or connectors (not shown) provide electrical interconnection between the HDA 214 and the PCBA 218. An interface connector 224 of the PCBA 218 enables interconnection of the device 200 with a host, such as the host 104 of FIG. 1.

The storage device 200 further comprises a LTIM 230 disposed between the HDA 214 and the PCBA 218. The LTIM 130 of FIG. 1 and the LTIM 230 of FIG. 2 are the same, and are discussed in further detail below. The LTIM 230 may be disposed between a heat sink (not shown) and a substrate (not shown) within the interior of the storage device 200. In other embodiments, the LTIM 230 is disposed between heat generating components, such as a controller (e.g., the controller 108 of the storage device 106 of FIG. 1), and a heat sink (not shown) and/or the enclosure 216. The LTIM 230 secures the PCBA 218 to the enclosure 216, conducts heat away from the PCBA 218 and/or the HDA 214 during device operation, and thermally isolates the PCBA 218 from the HDA 214. As such, heat generated by the PCBA 218 can be efficiently removed from the PCBA, and heat generated by the HDA 214 will not tend to increase the temperature of the PCBA (and vice versa).

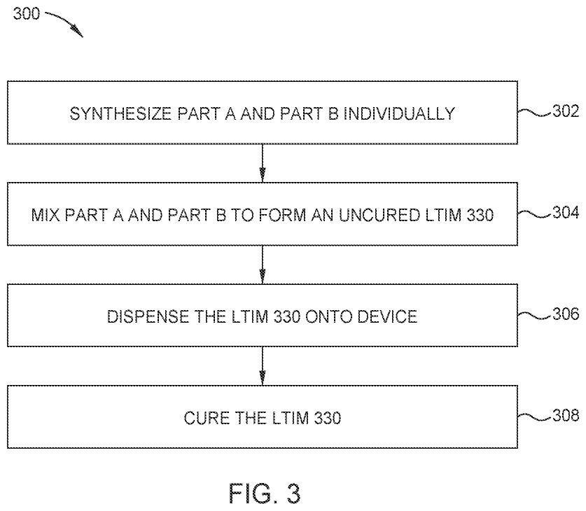

FIG. 3 illustrates a method 300 of forming a LTIM 330 utilized in an electronic device, according to one embodiment. The LTIM 330 may be used within the storage device 106 of FIG. 1 and/or the storage device 200 of FIG. 2. Furthermore, the LTIM 330 may be the LTIM 130 of FIG. 1 or the LTIM 230 of FIG. 2. As such, the LTIM 130 and the LTIM 230 of FIGS. 1 and 2 may be collectively referred to as the LTIM 330. Moreover, while the LTIM 330 is described as being utilized with storage devices throughout, the LTIM may be used with various types of electronics, such as electronics within automobiles, and the LTIM 330 is not limited to be utilized only with storage devices.

The LTIM 330 is a highly cross-linked non-oil bleed two-part silicone material that can be used as the thermal gap filler within storage devices 106, 200. The oil bleed or separation from the LTIM 330 can be reduced by increasing the crosslinking density, effectively mixing filler into the polymer composition, and by utilizing a high molecular weight polymer to restrict migration. The selection of filler type and size reduces the oil separation from the composite, preventing the exterior from being cosmetically damaged or operationally damaged.

The LTIM 330 comprises a first part, part A, and a second part, part B. In operation 302, part A and part B of the LTIM are individually synthesized. In operation 304, part A and part B are mixed at about a 0.8:1.2 ratio to about a 1.2:0.8 ratio, such as about a 1:1 ratio, to produce the uncured LTIM 330. The resultant LTIM 330 comprises about 93% filler and about 7% polymer and additives.

Part A of the LTIM 330 comprises a resin comprising siloxane in an amount of about 1 percentage by weight (wt%) to about 12 wt% of part A, such as about 6 wt% to about 7 wt%, an oxide filler in an amount of about 50 wt% to about 70 wt% of part A, such as about 57 wt% to about 63 wt%, a nitride filler in an amount of about 20 wt% to about 40 wt% of part A, such as about 30 wt% to about 35 wt%, a catalyst comprising platinum in an amount of about 0.001 wt% to about 0.05 wt% of part A, such as about 0.018 wt% to about 0.025 wt%, and an inhibitor comprising cyclohexanol in an amount of about 0.003% to about 0.05 wt% of part A, such as about 0.012 wt% to about 0.015 wt%.

Part B of the LTIM 330 comprises a chain extender comprising siloxane in an amount of about 0.1 wt% to about 2 wt% of part B, such as about 0.8 wt% to about 0.9 wt%, a crosslinker comprising siloxane in an amount of about 0.01 wt% to about 0.5 wt% of part B, such as about 0.1 wt% to about 0.2 wt%, an adhesive agent comprising siloxane in an amount of about 1 wt% to about 12 wt% of part B, such as about 6 wt% to about 7 wt%, the oxide filler in an amount of about 50 wt% to about 70 wt% of part B, such as about 60 wt% to about 65 wt%, and the nitride filler in an amount of about 15 wt% to about 40 wt% of part B, such as about 25 wt% to about 30 wt%.

Table 1 below shows an exemplary part A formulation composition, and Table 2 below shows an exemplary part B formulation composition.

TABLE 1
Part A

| Raw materials | Function | Percentage by Weight (wt %) |
|---|---|---|
| Dimethylpolysiloxane, dimethylvinylsilyl | Resin | About 1 to about 12 |
| terminated | | |
| Aluminum oxide | Filler | About 50 to about 70 |
| Boron Nitride | Filler | About 20 to about 40 |
| Platinum (0)-1, 3-divinyl- | Catalyst | About 0.001 to about 0.05 |
| 1, 1, 3, 3-tetramethyldisiloxane | | |
| 1-ethynyl-1-cyclohexanol | Inhibitor | About 0.003 to about 0.05 |

To synthesize part A in operation 302, the filler particles (e.g., Al₂O₃ and BN) are heated in a vacuum oven for about 24 hours at 100° C. to remove the physically adsorbed substance. The silicone resin (e.g., vinyl terminated, dimethylpolysiloxane) is mixed with the catalyst (e.g., platinum (O)-1, 3-divinyl-1, 1, 3, 3-tetramethyl-disiloxane) for uniform mixing at 800 rpm for about 600 seconds in a vacuum. Simultaneously, the Al₂O₃ and BN fillers are added into the mixture. The fillers are mixed with the silicone resin in a multi-step mixing process due to high filler loading. The multi-step mixing process is adapted to ensure homogenous mixing of particles. The fillers are mixed into the composition at speeds of 400 rpm for about 200 seconds, 1100 rpm for about 400 seconds, 1400 rpm for about 300 seconds, 1200 rpm for about 600 seconds, and 1500 rpm for about 500 seconds. The composition is then degassed in a vacuum to reduce air entrapments in the part A composition. Finally, the inhibitor (e.g., 1-ethynyl-1-cyclohexanol) is added to the composition and mixed at 800 rpm for about 400 seconds.

TABLE 2
Part B

| Raw materials | Function | Percentage by Weight (wt %) |
|---|---|---|
| Polydimethylsiloxane, Hydride | Chain extender | About 0.1 to about 2 |
| terminated | | |
| Polymethylhydrosiloxane, | Crosslinker | About 0.01 to about 0.5 |
| Trimethylsiloxy terminated | | |
| Single end trifunctional hydrolyzable | Adhesive agent | About 1 to about 12 |
| methylpolysiloxane | | |
| Aluminum oxide | Filler | About 50 to about 70 |
| Boron Nitride | Filler | About 15 to about 40 |

To synthesize part B in operation 302, the chain extender (e.g., hydride terminated, polydimethylsiloxane) and the adhesive agent (e.g., single end trifunctional hydrolyzable polydimethylsiloxane) are mixed at 800 rpm for about 600 seconds. Subsequently, the curing agent or crosslinker (e.g., trimethylsiloxy terminated, polydimethylsiloxane) is added to the mixture at 800 rpm and maintained for about 400 seconds in a vacuum. The filler particles (e.g., Al₂O₃ and BN) are then weighed and mixed into the composition at speeds of 400 rpm for about 400 seconds, 1200 rpm for about 200 seconds, 1100 rpm for about 500 seconds, 1500 rpm for about 400 seconds, and 1400 rpm for about 600 seconds. The composition is then degassed in a vacuum to reduce air entrapments in the part B composition.

To mix part A and part B in operation 304, the part A and part B mixtures are mixed together at about a 0.8:1.2 ratio to about a 1.2:0.8 ratio, such as about a 1:1 ratio, at speeds of 800 rpm, 1000 rpm, and 1200 rpm for about 400 seconds at each speed, and de-foamed at a pressure of about 5 kPa. It is to be noted that highly viscous compositions lead to overheating and triggers premature crosslinking. As such, the A and B compositions are cooled to room temperature after each mixing step. The mixed composition forms the uncured LTIM 330.

In operation 306, the uncured LTIM 330 is cast in a mold or dispensed onto a drive. Once the uncured LTIM 330 has been dispensed, the uncured LTIM 330 is at least partially cured in an oven at about 100° C. for about 20 minutes in operation 308. At least partially curing the LTIM 330 causes chemical reactions to occur, resulting in the LTIM 330 having the properties described below in Table 3. At least partially curing the LTIM 330 may be fully curing the LTIM 330. Curing the LTIM 330 hardens the LTIM 330, turning the LTIM 330 from a liquid to a solid.

A silicone resin (e.g., vinyl terminated, dimethylpolysiloxane) is utilized in the LTIM 330 because silicone elastomers are unique polymers owing to their semi-organic molecular structure. Most polymers are built with carbon-to-carbon backbone structure whereas silicones are built with silicone-to-oxygen structure. Silicone elastomers provide very high thermal stabilities (e.g., up to 300° C.) and are also flexible at very low temperature (e.g., -80° C.). Silicone resin can operate at very high and low-temperature extremes owing to their low moduli of elasticity, flexibility, moisture resistance, able to resist vibration and dissipate stresses. Silicones have comparatively low surface energy, and silicones bond well to many low surface energy plastics, such as the Al₂O₃ and BN fillers. Most commonly utilized ceramic fillers in electronics industries are Al₂O_{3,} ZnO, AIN, and/or BN for enhancing thermal conductivity of polymer composites.

In the uncured LTIM 330, a ratio of the (number of silicon atoms bonded to hydrogen atoms in the crosslinker and the chain extender)/(number of vinyl groups in the silicone resin) is about a 0.9 to 1.5 ratio, such as about a 1 to 1.2 ratio. When the ratio of the number of silicon atoms bonded to hydrogen atoms in the crosslinker and the chain extender to the number of vinyl groups in the silicone resin is above about 1.3, the crosslinking density of the composition will be higher than needed, causing the LTIM 330 to harden.

Aluminum oxide (Al₂O₃) is an odorless white crystalline powder. Aluminum oxide is an electrical insulator but has relatively high thermal conductivity. Aluminum oxide is utilized as a filler within the LTIM 330 because Al₂O₃ has a high hardness, chemical inertness, excellent dielectric properties, good thermal properties, and low coefficient of thermal expansion (CTE). Aluminum oxides are more cost-effective compared to other ceramics filler as well. The average particle diameter of the Al₂O₃ powder utilized is about 9 μm to about 16 μm, such as about 10 μm to about 15 μm. When average particle diameter of Al₂O₃ is above about 16 μm, the viscosity of composition will be higher.

Boron nitride (BN) powders are commonly used as reinforcements to improve the thermal conductivity of the polymer composites. Boron nitride is utilized as a filler within the LTIM 330 because BN has a high thermal conductivity, good oxidation resistance, high thermal and chemical stability, a low dielectric constant, and a high electrical resistivity. The Al₂O₃ and BN fillers act as a heat conduction path. When the thermal gap fillers (e.g., Al₂O₃ and BN) contact with the heat source(s) (e.g., controller, NAND, etc.), heat transfers quicker through the alumina/boron nitride fillers than the silicone resin. The average particle size of the BN powder utilized is about 1 μm to about 10 μm, such as about 1 μm to about 5 μm. The smaller particle size of the BN filler effectively fills the gaps between the larger Al₂O₃ filler.

Table 3 shows key properties of the at least partially cured LTIM 330 comprising part A and part B mixed compared to a conventional LTIM. Conventional LTIMs generally comprise alumina filled silicone elastomers, and comprise between about 80% to about 95% filler and about 5% to about 20% polymers and other additives. Such conventional LTIMS may comprise organopolysiloxane as a resin, organohydrogen-polysiloxane as a hardener, inorganic filler(s), a catalyst, and other additives, for example.

TABLE 3

| | | | LTIM 330 |
|---|---|---|---|
| | | | comprising |
| Typical properties | | Conventional LTIM | mixed parts A and B |
| Number of | | Two | Two |
| Components | | | |
| Mix Ratio | | 1:1 | 1:1 |
| Thermal conductivity | | 0.8-4.0 | 4.5-5.5 |
| (W/m.K) | | | |
| Hardness | | 40-90 | 70-85 |
| (Shore OO) | | | |
| Viscosity Pa.s | Part A | Non-comparable* | 160,000 |
| | Part B | | 47,600 |

| | | |
|---|---|---|
| Dielectric Constant @ | 7-9 | 4.8-5.5 |
| 1 MHz | | |
| Density (g/cc) | 2.0-3.3 | 1.5-2.0 |
| Cure Schedule | 100° C. for | 100° C. for |
| | 15-80 mins | 20 mins |

*Conventional LTIM was tested using different test methods and standards (Rheometer and Viscometer) provided by a supplier, hence non-comparable to the LTIM 330.

As shown in Table 3, the LTIM 330 has a significantly higher thermal conductivity measured using a measurement standard of ASTM D5470 of about 4.5 W/mK to about 5.5 W/mK compared to a thermal conductivity of about 0.8 W/mK to about 4.0 W/mK for a conventional LTIM. The LTIM 330 further has a lower density measured using a measurement standard of ASTM D792 of about 1.5 g/cc to about 2 g/cc compared to a density of about 2.0 g/cc to about 3.3 g/cc for a conventional LTIM. The lower density of the LTIM 330 minimizes stress that may arise through shock or vibration. Additionally, the LTIM 330 has a lower dielectric constant at 1 MHz measured using a measurement standard of ASTM D150 of about 4.8 to about 5.5 compared to a dielectric constant of about 7 to about 9 for a conventional LTIM.

Furthermore, the LTIM 330 does not result in oil bleeding like the conventional LTIM, as the conventional LTIM may have uncured polymers causing the LTIM to bleed oil. As such, storage devices utilizing the LTIM 330, such as storage device 106 of FIG. 1 and storage device 200 of FIG. 2, prevent contamination from occurring on enclosures or housings of the devices, and further prevent the adhesion strengths of the LTIM 330 from being reduced. The hardness of about 70 to about 85 of the LTIM 330 falls under the soft- medium soft category on the Shore 00 hardness scale, allowing the LTIM 330 to effectively fill any air voids at interfaces, accommodate macroscopic thickness variation along the surface, and stimulate heat transfer between two surfaces. Moreover, the LTIM 330 has a shorter curing period than the conventional LTIM, which allows for more devices to be produced in a shorter amount of time, increasing production output. Thus, the LTIM 330 not only prevents oil bleeding, but further has improved thermal dissipating or thermal regulating capabilities compared to a conventional LTIM.

To compare a storage device comprising the LTIM 330 to a storage device comprising the conventional LTIM, the enclosed temperatures of a first device utilizing the LTIM 330 and a second device utilizing a conventional LTIM were monitored over a period of time. Table 4 illustrates the enclosed temperatures of the first and second devices during operation in degrees Celsius at various time intervals in minutes (min).

TABLE 4

| Time | First device utilizing | Second device utilizing a |
|---|---|---|
| (min) | the LTIM 330 (° C.) | conventional LTIM (° C.) |
| 0 | About 28.7 | About 27.1 |
| 30 | About 58.9 | About 66.5 |
| 60 | About 59.0 | About 68.2 |
| 90 | About 59.9 | About 67.7 |
| 120 | About 60.1 | About 67.1 |

As demonstrated by Table 4, the first device utilizing the LTIM 330 was about 7° C. cooler than the second device utilizing a conventional LTIM after operating for 120 minutes. On average, over the entire 120 minute operating period, the enclosed temperature of the first device comprising the LTIM 330 was cooler than or about equal to the enclosed temperature of the second device utilizing a conventional LTIM. As such, the LTIM 330 reduces the enclosed temperature of a storage device about 11% compared to a conventional LTIM.

Furthermore, a highly accelerated stress test having parameters of 130° C. and a relative humidity of 85% was performed on the first device comprising the LTIM 330. The first device comprising the LTIM 330 was monitored continuously for periods of 96 hours, 180 hours, and 250 hours. At the conclusion of the highly accelerated stress test, no oil bleed was detected on the first device comprising the LTIM 330. Furthermore, a second prolonged oil bleed test was conducted on the enclosure of first device comprising the LTIM 330. After dispensing the LTIM 330 on the enclosure of the first device and curing, the enclosure having the cured LTIM 330 disposed thereon sat at room temperature (25 ° C.) for a period of time to cool. The enclosure having the cured LTIM 330 disposed thereon was then inspected five times: 1) immediately after dispensing, 2) after one month, 3) after two months, 4) after four months, and 5) after six months, respectively. At the conclusion of visual inspection over the six-month period, no oil bleed was detected on the first device comprising the cured LTIM 330.

Therefore, the LTIM 330 formed from mixed part A and part B comprising about 93% filler and about 7% polymer and additives has a higher thermal conductivity, a lower density, a lower dielectric constant, and a reduced curing time than conventional LTIMs, allowing the LTIM 330 to effectively dissipate heat and regulate the enclosed temperature of storage devices without causing oil to bleed. As such, the LTIM 330 prevents contamination from occurring on enclosures or housings of the devices, and further prevents the adhesion strengths of the LTIM 330 from being reduced. Due to the reduced curing time of the LTIM 330, production of such devices utilizing the LTIM 330 can be increased, resulting in a greater number of devices being produced in a shorter amount of time. Moreover, the LTIM 330 effectively fills any air voids at interfaces, accommodates macroscopic thickness variation along the surface, stimulates heat transfer between two surfaces, and minimizes stress that may arise through shock or vibration.

In one embodiment, a LTIM comprises an at least partially cured resin composition, wherein, prior to at least partially curing, the resin composition comprises a first part and a second part. The first part comprises a resin comprising polysiloxane in an amount of about 1 wt% to about 12 wt% of the first part, an oxide filler in an amount of about 50 wt% to about 70 wt% of the first part, a nitride filler in an amount of about 20 wt% to about 40 wt% of the first part, a catalyst in an amount of about 0.001 wt% to about 0.05 wt% of the first part, and an inhibitor in an amount of about 0.003 wt% to about 0.05 wt% of the first part. The second part comprises a chain extender comprising methylsiloxane in an amount of about 0.1 wt% to about 2 wt% of the second part, a crosslinker in an amount of about 0.01 wt% to about 0.5 wt% of the second part, an adhesive agent in an amount of about 1 wt% to about 12 wt% of the second part, the oxide filler in an amount of about 50 wt% to about 70 wt% of the second part, and the nitride filler in an amount of about 15 wt% to about 40 wt% of the second part.

The first part and the second part are mixed together at about a 1:1 ratio prior to at least partially curing. The oxide filler comprises aluminum oxide and the nitride filler comprises boron nitride. The resin comprises dimethylpolysiloxane, and the catalyst comprises platinum. The chain extender comprises polydimethylsiloxane, and the crosslinker comprises polymethylhydrosiloxane. The LTIM has a thermal conductivity between about 4.5 W/mK to about 5.5 W/mK, a dielectric constant at 1 MHz between about 4.8 and about 5.5, and a density less than about 2 g/cc. The resin composition is cured at a temperature of about 100° C. for about 20 minutes. The LTIM has a soft-medium soft hardness on the Shore OO hardness scale. A storage device comprises the LTIM.

In another embodiment, a storage device comprises an at least partially cured liquid thermal interface material (LTIM), wherein, prior to at least partially curing, the LTIM comprises a first part and a second part. The first part comprises a resin comprising dimethylpolysiloxane, an aluminum oxide filler, a boron nitride filler, a catalyst comprising platinum, and an inhibitor comprising cyclohexanol. The second part comprises a chain extender comprising polydimethylsiloxane, a crosslinker comprising polymethylhydrosiloxane, an adhesive agent comprising methylpolysiloxane, the aluminum oxide filler, and the boron nitride filler. The LTIM has a thermal conductivity between about 4.5 W/mK to about 5.5 W/mK, a density less than about 2 g/cc, and a dielectric constant at 1 MHz between about 4.8 and about 5.5.

A percentage by weight of the resin comprising dimethylpolysiloxane is between about 1 wt% to about 12 wt% of the first part, a percentage by weight of the catalyst comprising platinum is about 0.001 wt% to about 0.05 wt% of the first part, and a percentage by weight of the inhibitor comprising cyclohexanol is about 0.003 wt% to about 0.05 wt% of the first part. A percentage by weight of the chain extender comprising polydimethylsiloxane is about 0.1 wt% to about 2 wt% of the second part, a percentage by weight of the crosslinker comprising polymethylhydrosiloxane is about 0.01 wt% to about 0.5 wt% of the second part, and a percentage by weight of the adhesive agent comprising methylpolysiloxane is about 1 wt% to about 12 wt% of the second part.

A percentage by weight of the aluminum oxide filler in the first part is about 50 wt% to about 70 wt% of the first part, a percentage by weight of the aluminum oxide filler in the second part is about 50 wt% to about 70 wt% of the second part, a percentage by weight of the boron nitride filler in the first part is about 20 wt% to about 40 wt% of the first part, and a percentage by weight of the boron nitride filler in the second part is about 15 wt% to about 40 wt% of the second part. The first part and the second part are mixed together at about a 1:1 ratio prior to at least partially curing. The LTIM is cured at a temperature of about 100° C. for about 20 minutes. The first part and the second part are individually synthesized prior to mixing the first part and the second part together.

In yet another embodiment, an electronic device comprises an at least partially cured liquid thermal interface material (LTIM), wherein, prior to at least partially curing, the LTIM comprises a first part and a second part. The first part comprises a resin comprising polysiloxane in an amount of about 1 wt% to about 12 wt% of the first part, an aluminum oxide filler in an amount of about 50 wt% to about 70 wt% of the first part, and a boron nitride filler in an amount of about 20 wt% to about 40 wt% of the first part. The second part comprises a chain extender comprising methylsiloxane in an amount of about 0.1 wt% to about 2 wt% of the second part, the aluminum oxide filler in an amount of about 50 wt% to about 70 wt% of the second part, and the boron nitride filler in an amount of about 15 wt% to about 40 wt% of the second part. The LTIM has a thermal conductivity between about 4.5 W/mK to about 5.5 W/mK and a density less than about 2 g/cc.

The first part further comprises a catalyst comprising platinum in an amount of about 0.001 wt% to about 0.05 wt% of the first part, and an inhibitor in an amount of about 0.003 wt% to about 0.05 wt% of the first part. The second part further comprises a crosslinker comprising hydrosiloxane in an amount of about 0.01 wt% to about 0.5 wt% of the second part, and an adhesive agent comprising methylpolysiloxane in an amount of about 1 wt% to about 12 wt% of the second part. The first part and the second part are individually synthesized prior to at least partially curing the LTIM. The first part and the second part are mixed together at about a 1:1 ratio after individually synthesizing the first part and the second part. The LTIM is cured at a temperature of about 100° C. for about 20 minutes. The LTIM has a dielectric constant at 1 MHz between about 4.8 and about 5.5. The LTIM has a soft-medium soft hardness on the Shore OO hardness scale.

While the foregoing is directed to embodiments of the present disclosure, other and further embodiments of the disclosure may be devised without departing from the basic scope thereof, and the scope thereof is determined by the claims that follow.

What is claimed is:

1. A liquid thermal interface material (LTIM), comprising:
an at least partially cured resin composition, wherein, prior to at least partially curing, the resin composition comprises a first part and a second part,
the first part comprising:
a resin comprising polysiloxane in an amount of about 1 percentage by weight (wt%) to about 12 wt% of the first part;
an oxide filler in an amount of about 50 wt% to about 70 wt% of the first part;
a nitride filler in an amount of about 20 wt% to about 40 wt% of the first part;
a catalyst in an amount of about 0.001 wt% to about 0.05 wt% of the first part; and
an inhibitor in an amount of about 0.003 wt% to about 0.05 wt% of the first part; and
the second part comprising:
a chain extender comprising methylsiloxane in an amount of about 0.1 wt% to about 2 wt% of the second part;
a crosslinker in an amount of about 0.01 wt% to about 0.5 wt% of the second part;
an adhesive agent in an amount of about 1 wt% to about 12 wt% of the second part;
the oxide filler in an amount of about 50 wt% to about 70 wt% of the second part; and
the nitride filler in an amount of about 15 wt% to about 40 wt% of the second part.

2. The LTIM of claim 1, wherein the first part and the second part are mixed together at about a 1:1 ratio prior to at least partially curing.

3. The LTIM of claim 1, wherein the oxide filler comprises aluminum oxide and the nitride filler comprises boron nitride.

4. The LTIM of claim 1, wherein the resin comprises dimethylpolysiloxane, and the catalyst comprises platinum.

5. The LTIM of claim 1, wherein the chain extender comprises polydimethylsiloxane, and the crosslinker comprises polymethylhydrosiloxane.

6. The LTIM of claim 1, wherein the LTIM has a thermal conductivity between about 4.5 W/mK to about 5.5 W/mK, a dielectric constant at 1 MHz between about 4.8 and about 5.5, and a density less than about 2 g/cc.

7. The LTIM of claim 1, wherein the resin composition is cured at a temperature of about 100° C. for about 20 minutes, and wherein the LTIM has a soft-medium soft hardness on a Shore OO hardness scale.

8. A storage device comprising the LTIM of claim 1.

9. A storage device, comprising:
an at least partially cured liquid thermal interface material (LTIM), wherein, prior to at least partially curing, the LTIM comprises a first part and a second part,
the first part comprising:
a resin comprising dimethylpolysiloxane;
an aluminum oxide filler;
a boron nitride filler;
a catalyst comprising platinum; and
an inhibitor comprising cyclohexanol; and
the second part comprising:
a chain extender comprising polydimethylsiloxane;
a crosslinker comprising polymethylhydrosiloxane;
an adhesive agent comprising methylpolysiloxane;
the aluminum oxide filler; and
the boron nitride filler,
wherein the LTIM has a thermal conductivity between about 4.5 W/mK to about 5.5 W/mK, a density less than about 2 g/cc, and a dielectric constant at 1 MHz between about 4.8 and about 5.5.

10. The storage device of claim 9, wherein a percentage by weight (wt%) of the resin comprising dimethylpolysiloxane is between about 1 wt% to about 12 wt% of the first part, a percentage by weight of the catalyst comprising platinum is about 0.001 wt% to about 0.05 wt% of the first part, and a percentage by weight of the inhibitor comprising cyclohexanol is about 0.003 wt% to about 0.05 wt% of the first part.

11. The storage device of claim 9, wherein a percentage by weight of the chain extender comprising polydimethylsiloxane is about 0.1 wt% to about 2 wt% of the second part, a percentage by weight of the crosslinker comprising polymethylhydrosiloxane is about 0.01 wt% to about 0.5 wt% of the second part, and a percentage by weight of the adhesive agent comprising methylpolysiloxane is about 1 wt% to about 12 wt% of the second part.

12. The storage device of claim 9, wherein a percentage by weight of the aluminum oxide filler in the first part is about 50 wt% to about 70 wt% of the first part, a percentage by weight of the aluminum oxide filler in the second part is about 50 wt% to about 70 wt% of the second part, a percentage by weight of the boron nitride filler in the first part is about 20 wt% to about 40 wt% of the first part, and a percentage by weight of the boron nitride filler in the second part is about 15 wt% to about 40 wt% of the second part.

13. The storage device of claim 9, wherein the first part and the second part are mixed together at about a 1:1ratio prior to at least partially curing, and wherein the LTIM is cured at a temperature of about 100° C. for about 20 minutes.

14. The storage device of claim 13, wherein the first part and the second part are individually synthesized prior to mixing the first part and the second part together.

15. An electronic device, comprising:
an at least partially cured liquid thermal interface material (LTIM), wherein, prior to at least partially curing, the LTIM comprises a first part and a second part,
the first part comprising:
a resin comprising polysiloxane in an amount of about 1 percentage by weight (wt%) to about 12 wt% of the first part;
an aluminum oxide filler in an amount of about 50 wt% to about 70 wt% of the first part; and
a boron nitride filler in an amount of about 20 wt% to about 40 wt% of the first part; and
the second part comprising:
a chain extender comprising methylsiloxane in an amount of about 0.1 wt% to about 2 wt% of the second part;
the aluminum oxide filler in an amount of about 50 wt% to about 70 wt% of the second part; and
the boron nitride filler in an amount of about 15 wt% to about 40 wt% of the second part,
wherein the LTIM has a thermal conductivity between about 4.5 W/mK to about 5.5 W/mK and a density less than about 2 g/cc.

16. The electronic device of claim 15, wherein the first part further comprises:
a catalyst comprising platinum in an amount of about 0.001 wt% to about 0.05 wt% of the first part; and
an inhibitor in an amount of about 0.003 wt% to about 0.05 wt% of the first part.

17. The electronic device of claim 15, wherein the second part further comprises:
a crosslinker comprising hydrosiloxane in an amount of about 0.01 wt% to about 0.5 wt% of the second part; and
an adhesive agent comprising methylpolysiloxane in an amount of about 1 wt% to about 12 wt% of the second part.

18. The electronic device of claim 15, wherein the first part and the second part are individually synthesized prior to at least partially curing the LTIM, and wherein the first part and the second part are mixed together at about a 1:1 ratio after individually synthesizing the first part and the second part.

19. The electronic device of claim 18, wherein the LTIM is cured at a temperature of about 100° C. for about 20 minutes.

20. The electronic device of claim 15, wherein the LTIM has a dielectric constant at 1 MHz between about 4.8 and about 5.5, and wherein the LTIM has a soft-medium soft hardness on a Shore OO hardness scale.
